(19) United States
(12) Patent Application Publication
(10) Pub. No.: US 2014/0316034 A1
(43) Pub. Date: Oct. 23, 2014

(54) METHOD FOR PREPARING AN EPOXY BASED COATING COMPOSITION

(71) Applicants: KING ABDUL AZIZ CITY FOR SCIENCE AND TECHNOLOGY, Riyadh (SA); CHEMICAL PHYSICS TECHNOLOGIES LTD, Minsk (BY)

(72) Inventors: Mohammed Abdullah Bahattab, Riyadh (SA); Andrei V. Krauklis, Minsk (BY); Siarhei Zhdanok, Minsk (BY)

(73) Assignees: CHEMICAL PHYSICS TECHNOLOGIES LTD, Minsk (BY); KING ABDUL AZIZ CITY FOR SCIENCE AND TECHNOLOGY, Riyadh (SA)

(21) Appl. No.: 13/867,070

(22) Filed: Apr. 20, 2013

(51) Int. Cl. C09D 163/00

(52) U.S. Cl. CPC C09D 163/00
USPC 523/468

(57) ABSTRACT

The invention provides a method for preparing an epoxy based coating composition. The method includes preparing a first dispersion including one or more colorants, one or more fillers and an epoxy based paint work material dispersed in a first portion of one or more solvents. The first dispersion is prepared by dispersing the one or more colorants and the one or more fillers in the epoxy based paint work material dispersed in the first portion of the one or more solvents. The method further includes preparing a second dispersion including one or more types of carbon nanotubes, a second portion of the one or more solvents and a hardener. The second dispersion is prepared by dispersing the one or more types of carbon nanotubes and the second portion of the one or more solvents in the hardener. Additionally, the method includes mechanically mixing the first dispersion and the second dispersion.

### FIELD OF THE INVENTION

The invention generally relates to a method for preparing a coating composition. More specifically, the invention relates to a method for preparing an epoxy based coating composition.

### BACKGROUND OF THE INVENTION

Epoxy based materials are widely used in various industries. For instance, epoxy based paint work materials are widely used as coatings due to their protective and decorative properties. The epoxy based paint work materials are particularly used for protective-decorative coating of surfaces such as, but not limited to, metallic surfaces, machinery, devices and wooden surfaces. The epoxy based paint work materials possess a number of valuable properties such as high dielectric indicators, thermal stability, water resistance, acid resistance, alkali resistance; covering capacity and low shrinkage degree.

Typically, an epoxy based paint work material is prepared by dispersing colorants, fillers and solvent additive in an epoxy solution. Before applying the epoxy based paintwork material on a surface, a hardener is introduced into the epoxy based paint work material. However, a coating which results after hardening of the epoxy based paint work material possesses insufficient physiochemical properties.

Therefore, there is need for a method for preparing an improved epoxy based coating composition.

### BRIEF DESCRIPTION OF THE FIGURE

The accompanying figure together with the detailed description below forms part of the specification and serves to further illustrate various embodiments and to explain various principles and advantages all in accordance with the present invention.

FIG. 1 illustrates a flow diagram of a method for preparing an epoxy based coating composition in accordance with an embodiment of the invention.

### DETAILED DESCRIPTION OF THE INVENTION

Before describing in detail embodiments that are in accordance with the invention, it should be observed that the embodiments reside primarily in method steps related to preparing an epoxy based coating composition.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variations thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article, apparatus or composition that comprises the element.

Generally speaking, pursuant to various embodiments, the invention provides a method for preparing an epoxy based coating composition. The method includes preparing a first dispersion including one or more colorants, one or more fillers and an epoxy based paint work material dispersed in a first portion of one or more solvents. The first dispersion is prepared by dispersing the one or more colorants and the one or more fillers in the epoxy based paint work material dispersed in the first portion of the one or more solvents. The method further includes preparing a second dispersion including one or more types of carbon nanotubes, a second portion of the one or more solvents and a hardener. The second dispersion is prepared by dispersing the one or more types of carbon nanotubes and the second portion of the one or more solvents in the hardener. In addition, the method includes mechanically mixing the first dispersion and the second dispersion.

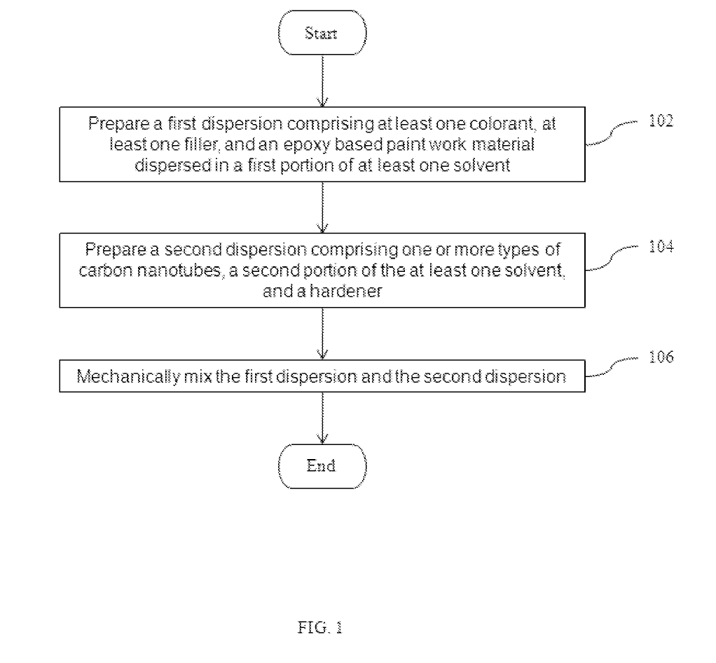

FIG. 1 illustrates a flow diagram of a method for preparing an epoxy based coating composition in accordance with an embodiment of the invention.

At step 102, a first dispersion including one or more colorants, one or more fillers and an epoxy based paint work material in first portion of one or more solvents is prepared. The first dispersion is prepared by dispersing the one or more colorants and the one or more fillers in the epoxy based paint work material dispersed in first portion of the one or more solvents. The one or more colorants can include, but are not limited to, organic pigments such as azo dyes and polycyclic pigments and inorganic pigments such as iron oxides, zinc chromates, azurite, chromium oxide, cadmium sulphide, lipthopone, zinc oxide and titanium oxide. The one or more fillers can include, but are not limited to, balsa dust, sawdust, sand, silica, microspheres, fiber, wood flour, graphite powder, calcium carbonate and talc. The one or more solvents can include, but not limited to, white spirit, mineral turpentine, acetone, methyl ethyl ketone, toluene and xylene. In an embodiment, the epoxy based paint work material is an epoxy resin based paint work material.

At step 104, a second dispersion including one or more types of carbon nanotubes, a second portion of the one or more solvents and a hardener is prepared. Any suitable type of carbon nanotubes can also be used for preparing the second dispersion. For example, single-walled carbon nanotubes or a combination of single-walled and multi-walled carbon nanotubes can be used for preparing the second dispersion. In an embodiment, two or more types of carbon nanotubes such as, but not limited to, single-walled carbon nanotubes, double walled carbon nanotubes and multi-walled carbon nanotubes can be used for preparing the second dispersion. The second dispersion is prepared by dispersing the one or more types of carbon nanotubes and the second portion of the one or more solvents in the hardener.

In an embodiment, the second dispersion is prepared by dispersing about 0.1 weight percentage (wt %) to about 2.0 wt % of the one or more types of carbon nanotubes, about 10 wt % to about 15 wt % of the second portion of the one or more solvents and the hardener for the rest.

In an embodiment, the second dispersion is prepared by treating the one or more types of carbon nanotubes, the second portion of the one or more solvents and the hardener in an ultrasonic bath. In an embodiment, the one or more types of carbon nanotubes, the second portion of the one or more solvents and the hardener are treated in the ultrasonic bath for a period of about 5 minutes to about 20 minutes. In an embodiment, the one or more types of carbon nanotubes, the second portion of the one or more solvents and the hardener are treated in the ultrasonic bath at a temperature of about 20° C. to about 27° C. In an embodiment, the one or more types of carbon nanotubes, the second portion of the one or more solvents and the hardener are treated in the ultrasonic bath at a frequency of about 22 kilohertz (khz) For example, the second dispersion can be prepared by treating about 0.1 wt % to about 2.0 wt % of the one or more types of carbon nanotubes, about 10 wt % to about 15 wt % of the second portion of the one or more solvents and the hardener for the rest in the ultrasonic bath for a period of about 10 minutes, wherein the operating temperature is about 23° C. and the operating frequency is about 22 khz.

At step 106, the first dispersion and the second dispersion are mechanically mixed. Any suitable mechanical mixing device can be used for mechanically mixing the first dispersion and the second dispersion. For example, mechanical mixing devices such as, but not limited to, magnetic stirring plates and motor-driven stirring blades can be used for mechanically mixing the first dispersion and the second dispersion.

In an embodiment, the first dispersion is mechanically mixed with the second dispersion for a period of about 5 minutes to about 20 minutes. In an embodiment, the first dispersion is mechanically mixed with the second dispersion at a speed of about 500 rotations per minute (rpm) to about 1600 rpm. In another embodiment, the first dispersion is mechanically mixed with the second dispersion at a speed of about 1400 rpm to 1600 rpm. In one embodiment, the mechanical mixing is carried out for a period of 15 minutes and at a speed of about 1450 rpm.

### WORKING EXAMPLE

0.01 grams (g) of carbon nanotubes were treated with 10 milliliter (ml) of hardener TS 6-10-1279-77 in an ultrasonic bath for 15 minutes to obtain a dispersion of hardener TS 6-10-1279-77 with the carbon nanotubes. The dispersion of hardener TS 6-10-1279-77 with the carbon nanotubes was mixed with 30 ml of epoxy based paint work material Enamel-EP-140 (311-140) for a period of 15 minutes with a speed of 1500 rpm.

The epoxy based coating compositions prepared using the method described herein have improved physiochemical properties. The physiochemical properties improve due to preliminary mixing of carbon nanotubes and solvent with the hardener. The combined introduction of carbon nanotubes and solvent in the hardener, before mixing with the epoxy based paint work material, does not influence on the viscosity of final product. At the same time, the combined introduction improves the physicochemical properties of the coating. During the process of hardening of the coating, the hardener is uniformly distributed on the surface of epoxy based paint work material, which provides uniformity to the coating. Additionally, an improved coating structure with reduced internal voltages in an enamel of epoxy based coating composition is formed due to preliminary mixing of carbon nanotubes and solvent with the hardener. The expenditure on hardener also reduces up to 11% to 17% when compared with conventional methods used to prepare the epoxy based coating composition.

Various epoxy based coating compositions including different wt % of carbon nanotubes were prepared using the method described above. Various tests were performed on the epoxy based coating compositions prepared using the method described above. The tests were performed to check the physio-chemical properties of the epoxy based coating compositions. The table below provides data regarding the tests performed on the epoxy based coating compositions including different wt % of carbon nanotubes which were prepared using the method described above.

| Composition of hardener for | | | | | | | |
|---|---|---|---|---|---|---|---|
| the epoxy based paint work | | | | | | | |
| composition | | | Physicochemical properties | | | | |
| | | | | | | | Film water |
| | Carbon | | | | Bending | Film stroke | resistance |
| | nano | | | | strength | resistance | at 18° C. |
| Hardener | Tubes | Solvent | | Film | (in milli- | (in Newton | to 22° C. |
| (in wt %) | (in wt %) | (in wt %) | Viscosity | hardness | meters) | per meter) | (in hours) |
| 100 | — | — | 13-18 | 0.6 | 3 | 5 | 24 |
| 87 | 0.6 | 12 | 13-18 | 0.6 | 3 | 5 | 24 |
| 87.2 | 0.8 | 12 | 13-18 | 0.7 | 2 | 5 | 26 |
| 86.7 | 1.3 | 12 | 13-18 | 1.0 | 2 | 5 | 30 |
| 86.1 | 1.9 | 12 | 13-18 | 1.0 | 2 | 5 | 34 |
| 86 | 2.0 | 12 | 20-25 | 1.0 | 2 | 5 | 34 |
| 90.7 | 1.3 | 8 | 13-18 | 0.7 | 2 | 5 | 28 |
| 88.7 | 1.3 | 10 | 13-18 | 0.8 | 2 | 5 | 30 |
| 83.7 | 1.3 | 15 | 13-18 | 1.0 | 2 | 5 | 34 |
| 81.7 | 1.3 | 17 | 13-18 | 1.0 | 2 | 5 | 30 |

The data in the table above indicates that when carbon nanotubes are dispersed in an epoxy based coating composition, the physiochemical properties of the epoxy based coating composition are improved. Based on the observations, the viscosity of the epoxy based coating composition remains invariable, coating hardness increases from 0.6 to 1 standard unit, the value of bending strength reduces from 3 millimeter (mm) to 2 mm and the water resistance increases from 24 to 34 hours.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for preparing an epoxy based coating composition comprising:
preparing a first dispersion comprising at least one colorant, at least one filler, and an epoxy based paint work material dispersed in a first portion of at least one solvent, wherein the first dispersion is prepared by dispersing the at least one colorant and the at least one filler in the epoxy based paint work material dispersed in the first portion of the at least one solvent;
preparing a second dispersion comprising one or more types of Carbon Nano Tubes (CNTs), a second portion of the at least one solvent, and a hardener, wherein the second dispersion is prepared by dispersing the one or more types of CNTs and the second portion of the at least one solvent in the hardener; and
mechanically mixing the first dispersion and the second dispersion.

2. The method of claim 1, wherein the epoxy based paint work material is an epoxy resin based paint work material.

3. The method of claim 1, wherein the second dispersion is prepared by treating the one or more types of CNTs and the second portion of the at least one solvent with the hardener in an ultrasonic bath.

4. The method of claim 3, wherein the second dispersion is prepared by treating the one or more types of CNTs and the second portion of the at least one solvent with the hardener in the ultrasonic bath for a period of about 5 minutes to about 20 minutes.

5. The method of claim 3, wherein the second dispersion is prepared by treating the one or more types of CNTs and the second portion of the at least one solvent with the hardener in the ultrasonic bath at a temperature of about 20° C. to about 27° C.

6. The method of claim 3, wherein the second dispersion is prepared by treating the one or more types of CNTs and the second portion of the at least one solvent with the hardener in the ultrasonic bath at a frequency of about 22 kilohertz (khz).

7. The method of claim 1, wherein the first dispersion is mechanically mixed with the second dispersion for a period of about 5 minutes to about 20 minutes.

8. The method of claim 1, wherein the first dispersion is mechanically mixed with the second dispersion at a speed of about 500 rotations per minute (rpm) to about 1600 rpm.

9. The epoxy based coating composition of claim 1, wherein the second dispersion comprises:
about 0.1 weight percentage (wt %) to about 2.0 wt % of the one or more types of CNTs;
about 10 wt % to about 15 wt % of the second portion of the at least one solvent; and
the hardener for the rest.
